(19) United States
(12) Patent Application Publication
(10) Pub. No.: US 2026/0352606 A1
(43) Pub. Date: Nov. 5, 2026

(54) PDCP REORDERING ENHANCEMENTS

(71) Applicant: Apple Inc., Cupertino, CA (US)

(72) Inventors: Ralf Rossbach, Munich (DE); Ping-Heng Kuo, London (GB); Fangli Xu, Beijing (CN); Haijing Hu, Los Gatos, CA (US)

(21) Appl. No.: 19/124,557

(22) PCT Filed: Nov. 4, 2022
(86) PCT No.: PCT/CN2022/129990

§ 371 Date: Apr. 25, 2025

(51) Int. Cl. H04L 47/31; H04L 47/34; H04W 28/06

(52) U.S. Cl. CPC H04L 47/31; H04L 47/34; H04W 28/06

(57) ABSTRACT

Methods, systems, apparatuses, and computer programs for updating a packet data convergence protocol (PDCP) reordering window are disclosed. In one aspect, a method can include, receiving, by a PDCP receiver, a discard indication indicating one or more PDCP PDUs as discarded PDUs, determining, by the PDCP receiver, whether a reordering timer is running, and based on a determination that the reordering timer is running, updating, by the PDCP receiver, an upper end of the reordering window to a first value that is determined by adjusting a value of a first state variable based on a number of subsequently discarded PDUs.

### BACKGROUND

Wireless communication networks provide integrated communication platforms and telecommunication services to wireless user devices. Example telecommunication services include telephony, data (e.g., voice, audio, and/or video data), messaging, internet-access, and/or other services. The wireless communication networks have wireless access nodes that exchange wireless signals with the wireless user devices using wireless network protocols, such as protocols described in various telecommunication standards promulgated by the Third Generation Partnership Project (3GPP). Example wireless communication networks include code division multiple access (CDMA) networks, time division multiple access (TDMA) networks, frequency-division multiple access (FDMA) networks, orthogonal frequency-division multiple access (OFDMA) networks, Long Term Evolution (LTE), and Fifth Generation New Radio (5G NR). The wireless communication networks facilitate mobile broadband service using technologies such as OFDM, multiple input multiple output (MIMO), advanced channel coding, massive MIMO, beamforming, and/or other features.

### SUMMARY

In XR operation, packet data convergence protocol (PDCP) operation includes a packet discard option where PDUs are discarded at a fairly regular basis such that packet discarding is no longer an abnormal event. In the conventional PDCP operation the discarding of a PDCP SDU already associated with a PDCP SN causes a SN gap in the transmitted PDCP Data PDUs, which increases PDCP reordering delay in the receiving PDCP entity. XR on the other hand requires low delay, and processing overhead and the use of system resources (including memory at the PDCP receiver) should be minimized.

Conventional systems have had PDCP transmitters that are plagued with the processing overhead of PDCP packet discarding. However, the present disclosure provides systems and methods for minimizing the overhead of a PDCP transmitter as a result of PDCP packet discarding by enhancing functionality of the PDCP receiver.

In particular, the present disclosure enhances a PDCP receiver to identify and process discarded PDCP PDUs. The discard indication indicates one or more PDCP PDUs that have been identified as discarded by the PDPC transmitter, but still ultimately transmitted by the PDCP transmitter. Based on this discard indication or based on the packet header of a PDU Set, the PDCP receiver can update one or more PDCP state variables, set a boundary of a PDCP reordering window, process discarded PDCP PDUs, or a combination thereof. This functionality of the PDCP receiver alleviates the PDCP transmitter from performing discard operations, which is a computationally intensive task as PDCP PDU discarding by a PDCP transmitter may occur after the PDCP PDU has been enciphered or after the PDCP PDU was transmitted to a lower level protocol.

According to one innovative aspect of the present disclosure, a method for updating a packet data convergence protocol (PDCP) reordering window is disclosed. In one aspect, the method can include receiving, by a PDCP receiver, a discard indication indicating one or more PDCP PDUs as discarded PDUs, determining, by the PDCP receiver, whether a reordering timer is running, and based on a determination that the reordering timer is running, updating, by the PDCP receiver, an upper end of the reordering window to a first value that is determined by adjusting a value of a first state variable based on a number of subsequently discarded PDUs.

Other aspects includes apparatuses, systems, and computer programs for performing the actions of the aforementioned method.

The innovative method can include other optional features. For example, in some implementations, the value of the first state variable corresponds to a sequence count value following a sequence count value associated with a PDCP Data PDU that triggered the reordering timer.

In some implementations, the method can further include based on a determination that the reordering timer is not running, updating, by the PDCP receiver, a lower end of the reordering window to a second value that is determined by adjusting a value of a second state variable based on the number of subsequently discarded PDUs.

In some implementations, the value of the second state variable corresponds to a sequence count value of a first PDCP SDU that is (i) not delivered to an upper layer and (ii) still waited for by a receiving device.

In some implementations, the method further include updating, by the PDCP receiver, a value of a third state variable based on a number of consecutively discarded PDUs.

In some implementations, the method can further include determining, by the PDCP receiver, that (i) a value of the second state variable corresponds to a sequence count value of a first PDCP SDU that is (a) not delivered to an upper layer and (b) still waited for by a receiving device and (ii) a value of the third state variable based on a number of consecutively discarded PDUs; and based on a determination that the value of the second state variable is equal to the value of the third state variable: delivering, by the PDCP receiver, to an upper layer protocol all stored PDCP SDUs with consecutively associated values starting from sequence number equal to a value of the second state variable, and updating, by the PDCP receiver, the value of the second state variable to a sequence number of a first PDCP SDU that has not been delivered to upper layers.

In some implementations, the updated value of the second state variable is a sequence number greater than the value of the second state variable before updating.

In implementations, the stored PDCP SDUs with consecutively associated values are delivered after header decompression.

According to another innovative aspect of the present disclosure, a method for updating a packet data convergence protocol (PDCP) state variables is disclosed. In one aspect, the method can include receiving, by a PDCP receiver, a discard indication indicating one or more PDCP PDUs as discarded PDUs, and based on receipt of the discard indication, updating, by the PDCP receiver, the values of one or more PDCP state variables based on the received discard indication.

Other aspects includes apparatuses, systems, and computer programs for performing the actions of the aforementioned method.

The innovative method can include other optional features. For example, in some implementations, the one or more PDCP state variables comprise a first state variable first state variable corresponding to a sequence count value following a sequence count value associated with a PDCP Data PDU that triggered the reordering timer.

In some implementations, updating the first state variable can include adjusting, by the PDCP receiver, a value of the first state variable based on a number of subsequently discarded PDUs.

In some implementations, the one or more PDCP state variables comprise a second state variable corresponding to a sequence count value of a first PDCP SDU that is (i) not delivered to an upper layer and (ii) still waited for by a receiving device.

In some implementations, adjusting a value of the second state variable based on a number of subsequently discarded PDUs comprises adding a value corresponding to the number of subsequently discarded PDUs to the value of the second state variable.

According to another innovative aspect of the present disclosure, a method for processing packet data convergence protocol (PDCP) PDUs indicated as discarded is disclosed. In one aspect, the method can include actions of receiving, by a PDCP receiver, a PDCP PDU that has been indicated, by a PDCP PDU transmitter, as discarded, and processing, by the PDCP receiver, the received PDCP PDU.

Other aspects includes apparatuses, systems, and computer programs for performing the actions of the aforementioned method.

The innovative method can include other optional features. For example, in some implementations, processing, by the PDCP receiver, the received PDCP PDU comprises: discarding, by the PDCP receiver, the received PDCP PDU.

In some implementations, discarding, by the PDCP receiver, the received PDCP PDU comprises: discarding, by the PDCP receiver, the received PDCP PDU only after a predetermined period of time has expired after receipt of the PDCP PDU.

In some implementations, discarding, by the PDCP receiver, the received PDCP PDU comprises: discarding, by the PDCP receiver, the received PDCP PDU upon receipt.

In some implementations, processing, by the PDCP receiver, the received PDCP PDU can include delivering, by the PDCP receiver, the received PDCP PDU to one or more upper layer protocols.

In some implementations, the method can further include receiving, by the PDCP receiver, a request for retransmission of one or more PDCP PDUs that include the received PDCP PDU that was indicated as discarded, and prohibiting, by the PDCP receiver, a request for retransmission of the received PDCP PDU that was indicated as discarded from being transmitted to the PDCP transmitter.

The details of one or more embodiments of these systems and methods are set forth in the accompanying drawings and the description below. Other features, objects, and advantages of these systems and methods will be apparent from the description and drawings, and from the claims.

### BRIEF DESCRIPTION OF THE DRAWINGS

FIG. 1 illustrates a wireless network, according to some implementations.

FIG. 2 is a flowchart of a process for updating PDCP state variables by a PDCP receiver based on a received discard indication

FIG. 3 is a flowchart of a process for using updated PDCP state variables by a PDCP receiver to set a boundary of a PDCP reordering window.

FIG. 4 is a flowchart of a process for processing a discarded PDCP PDU by a PDCP receiver.

FIG. 5 illustrates a user equipment (UE), according to some implementations.

FIG. 6 illustrates an access node, according to some implementations.

### DETAILED DESCRIPTION

The present disclosure is directed to apparatus, systems, and methods for identifying and processing discarded PDCP PDUs by a PDCP receiver. The PDCP receiver can receive a discard indication from a PDCP transmitter that indicates one or more PDCP PDUs that have been identified by the PDCP transmitter as discarded, but still transmitted by the PDCP transmitter.

Alternatively, in some cases, the PDCP receiver may infer discarded packets (or identify a sequence number gap) from packet headers associated with a PDU Set. The PDCP receiver can then update one or more PDCP state variables, set a boundary of a PDCP reordering window, process one or more discarded PDCP PDU packets, or a combination thereof, by based on receipt of the discard indication.

This PDCP receiver functionality provides a technological improvement to the overall communications system, as it minimizes processing overhead associated with discarded PDCP PDUs. For example, in conventional communication systems, when packet discarding happens after a PDU has been enciphered or when to be discarded PDUs are already submitted to lower layers and the PDUs are already part of a time-critical operation in RLC (with state variables assigned) or MAC (LCP is running, ongoing generation of a MAC PDU, etc.), discarding can be complicated (involves concurrency, causing high CPU load) and computationally intensive at the transmitter.

This reduction in processing overhead results in an overall PDCP reordering delay during packet discarding. Such reduction in overall PDCP reordering delay is essential to XR communications, which require low latency.

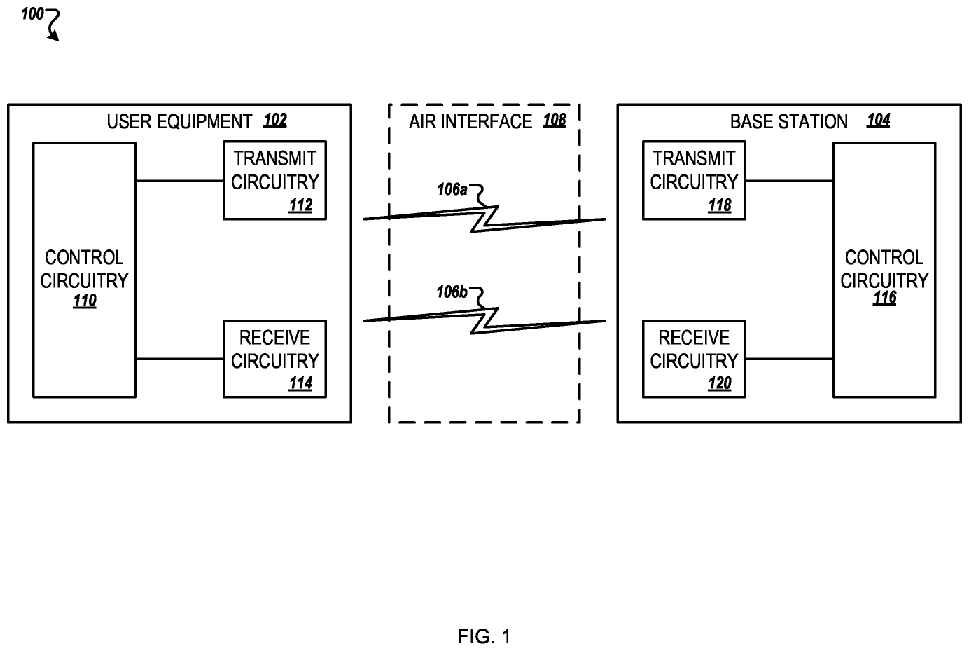

FIG. 1 illustrates a wireless network 100, according to some implementations. The wireless network 100 includes a UE 102 and a base station 104 connected via one or more channels 106A, 106B across an air interface 108. The UE 102 and base station 104 communicate using a system that supports controls for managing the access of the UE 102 to a network via the base station 104.

In some implementations, the wireless network 100 may be a Non-Standalone (NSA) network that incorporates Long Term Evolution (LTE) and Fifth Generation (5G) New Radio (NR) communication standards as defined by the Third Generation Partnership Project (3GPP) technical specifications. For example, the wireless network 100 may be a E-UTRA (Evolved Universal Terrestrial Radio Access)-NR Dual Connectivity (EN-DC) network, or a NR-EUTRA Dual Connectivity (NE-DC) network. However, the wireless network 100 may also be a Standalone (SA) network that incorporates only 5G NR. Furthermore, other types of communication standards are possible, including future 3GPP systems (e.g., Sixth Generation (6G)) systems, Institute of Electrical and Electronics Engineers (IEEE) 802.11 technology (e.g., IEEE 802.11a; IEEE 802.11b; IEEE 802.11g; IEEE 802.11-2007; IEEE 802.11n; IEEE 802.11-2012; IEEE 802.11ac; or other present or future developed IEEE 802.11 technologies), IEEE 802.16 protocols (e.g., WMAN, WiMAX, etc.), or the like. While aspects may be described herein using terminology commonly associated with 5G NR, aspects of the present disclosure can be applied to other systems, such as 3G, 4G, and/or systems subsequent to 5G (e.g., 6G).

In the wireless network 100, the UE 102 and any other UE in the system may be, for example, laptop computers, smartphones, tablet computers, machine-type devices such as smart meters or specialized devices for healthcare, intelligent transportation systems, or any other wireless devices with or without a user interface. In network 100, the base station 104 provides the UE 102 network connectivity to a broader network (not shown). This UE 102 connectivity is provided via the air interface 108 in a base station service area provided by the base station 104. In some implementations, such a broader network may be a wide area network operated by a cellular network provider, or may be the Internet. Each base station service area associated with the base station 104 is supported by antennas integrated with the base station 104. The service areas are divided into a number of sectors associated with certain antennas. Such sectors may be physically associated with fixed antennas or may be assigned to a physical area with tunable antennas or antenna settings adjustable in a beamforming process used to direct a signal to a particular sector.

The UE 102 includes control circuitry 110 coupled with transmit circuitry 112 and receive circuitry 114. The transmit circuitry 112 and receive circuitry 114 may each be coupled with one or more antennas. The control circuitry 110 may include various combinations of application-specific circuitry and baseband circuitry. The transmit circuitry 112 and receive circuitry 114 may be adapted to transmit and receive data, respectively, and may include radio frequency (RF) circuitry or front-end module (FEM) circuitry.

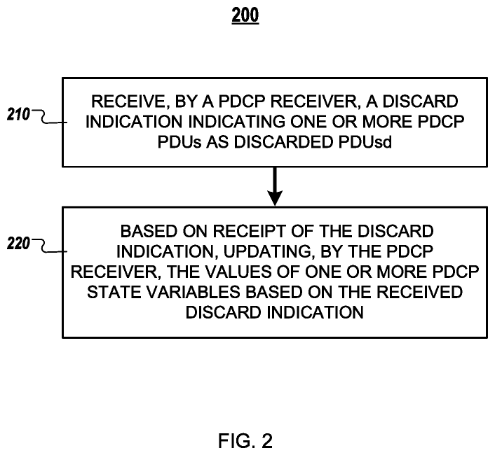

In various implementations, aspects of the transmit circuitry 112, receive circuitry 114, and control circuitry 110 may be integrated in various ways to implement the operations described herein. The control circuitry 110 may be adapted or configured to perform various operations such as those described elsewhere in this disclosure related to a UE. For instance, when the UE 102 is a PDCP receiver the control circuitry 110 can perform operations related to updating PDCP state variables, updating a bound of a PDCP reordering window, processing discarded PDCP PDUs, or a combination thereof. These operations can include, for example, one or more operations of one or more of FIGS. 2-4.

The transmit circuitry 112 can perform various operations described in this specification. For example, when the UE is a PDCP transmitter the transmit circuitry 112 can, for example, transmit a discard indication, one or more discarded PDCP PDUs, or a combination thereof. Additionally, the transmit circuitry 112 may transmit a plurality of multiplexed uplink physical channels. The plurality of uplink physical channels may be multiplexed according to time division multiplexing (TDM) or frequency division multiplexing (FDM) along with carrier aggregation. The transmit circuitry 112 may be configured to receive block data from the control circuitry 110 for transmission across the air interface 108.

The receive circuitry 114 can perform various operations described in this specification. For instance, when the UE is a PDCP receiver, the UE can use the receive circuitry 114 to receive a discard indication and one or more discarded PDCP PDUs. Additionally, the receive circuitry 114 may receive a plurality of multiplexed downlink physical channels from the air interface 108 and relay the physical channels to the control circuitry 110. The plurality of downlink physical channels may be multiplexed according to TDM or FDM along with carrier aggregation. The transmit circuitry 112 and the receive circuitry 114 may transmit and receive both control data and content data (e.g., messages, images, video, etc.) structured within data blocks that are carried by the physical channels.

FIG. 1 also illustrates the base station 104. In implementations, the base station 104 may be an NG radio access network (RAN) or a 5G RAN, an E-UTRAN, a non-terrestrial cell, or a legacy RAN, such as a UTRAN or GERAN. As used herein, the term “NG RAN” or the like may refer to the base station 104 that operates in an NR or 5G wireless network 100, and the term “E-UTRAN” or the like may refer to a base station 104 that operates in an LTE or 4G wireless network 100. The UE 102 utilizes connections (or channels) 106A, 106B, each of which includes a physical communications interface or layer.

The base station 104 circuitry may include control circuitry 116 coupled with transmit circuitry 118 and receive circuitry 120. The transmit circuitry 118 and receive circuitry 120 may each be coupled with one or more antennas that may be used to enable communications via the air interface 108. The transmit circuitry 118 and receive circuitry 120 may be adapted to transmit and receive data, respectively, to any UE connected to the base station 104. The transmit circuitry 118 may transmit downlink physical channels includes of a plurality of downlink subframes. In addition, for example, when the base station 104 is a PDCP transmitter, the base station can use the transmit circuitry 118 to, for example, transmit a discard indication, one or more discarded PDCP PDUs, or a combination thereof. The base station 104 may use receive circuitry 120 to receive a plurality of uplink physical channels from various UEs, including the UE 102. In addition, when the base station 104 is the PDCP receiver, the base station 104 can receive or detect a discard indication, one or more discarded PDCP PDUs, or both, using the receive circuitry 120. In addition, the when the base station 104 is a PDCP receiver, the base station 104 can use the control circuitry to perform operations related to updating PDCP state variables, updating a bound of a PDCP reordering window, processing discarded PDCP PDUs, or a combination thereof. These operations can include, for example, one or more operations of FIGS. 2-4.

In FIG. 1, the one or more channels 106A, 106B are illustrated as an air interface to enable communicative coupling, and can be consistent with cellular communications protocols, such as a GSM protocol, a CDMA network protocol, a UMTS protocol, a 3GPP LTE protocol, an Advanced long term evolution (LTE-A) protocol, a LTE-based access to unlicensed spectrum (LTE-U), a 5G protocol, a NR protocol, an NR-based access to unlicensed spectrum (NR-U) protocol, and/or any of the other communications protocols discussed herein. In implementations, the UE 102 may directly exchange communication data via a ProSe interface. The ProSe interface may alternatively be referred to as a sidelink (SL) interface and may include one or more logical channels, including but not limited to a Physical Sidelink Control Channel (PSCCH), a Physical Sidelink Control Channel (PSCCH), a Physical Sidelink Discovery Channel (PSDCH), and a Physical Sidelink Broadcast Channel (PSBCH).

### Discard Indicator

A majority of packets (complete PDU Sets or certain PDUs of a PDU Set) may be discarded at PDCP level. To assist the reordering function at the PDCP receiver to minimize reordering delay, a discard indicator can be used to inform the receiver of the PDCP PDUs that are discarded. The discard indicator can generated by a PDCP transmitter and indicate one or more PDCP PDUs that the PDCP transmitter determined should be discarded. In some implementations, discard indicator can indicate a range of PDCP PDUs that have been discarded by a PDCP transmitter using a PDCP PDU sequencer number (SN) or PDCP COUNT range.

In some implementations, a discard indicator can be implemented using a Control PDU or a Status PDU. In other implementations, packets that are to be discarded may be indicated using PDCP PDU header information.

The PDCP receiver, based on receipt of one or more discard indicators, can account for PDUs discarded by the PDCP transmitter as part of receive operation, reordering and in-order delivery. The SN gap pertaining to the discarded PDUs does not trigger out-of-sequence operation. In other words the received PDUs are considered in-sequence in spite of the SN gap. In some instances, this may include updates to PDCP receive state variables with regards to reordering window and next expected SNs.

Moreover, for SDUs or PDUs intended to be discarded but submitted by the PDCP transmitter to lower layers, the receiver may perform a discard on the receiving end. Alternatively, the receiver may decide to deliver the discarded PDCP SDUs to upper layers nevertheless (e.g., based on implementation or based on network configuration (for a UE) or operator configuration (for a gNB).

### PDCP Reordering Window

The NR PDCP Window_Size parameter indicates the size of the reordering window. The reordering window can be configured by the network based on the sequence number space. In some implementations, the parameter Window_Size value equals to 2^{pdcp-SN-SizeDL}−1 for signaling radio bearer (SRB)/data radio bearer (DRB)/MBS Radio Bearer (MRB). The parameter PDCP-SN-SIZEDL can be set using a PDCP-config for a specific SRB/DRB/MRB.

### PDCP State Variables

A PDCP receiver may track a number of different PDCP state variables having a corresponding value. A list of PDCP state variables tracked by a PDCP receiver can include TX_NEXT, RX_NEXT, RX_DELIV, and RX_REORD.

TX_NEXT is a PDCP state variable that indicates the COUNT value of the next PDCP SDU to be transmitted. RX_NEXT is a PDCP state variable that indicates the COUNT value of the next PDCP SDU expected to be received. RX_DELIV is a PDCP state variable indicates the COUNT value of the first PDCP SDU not delivered to the upper layers, but still waited for. RX_DELIV indicates the lower end of the PDCP reordering window. RX_REORD is a PDCP state variable that indicates the COUNT value following the COUNT value associated with the PDCP Data PDU which triggered t-Reordering reordering timer. RX_REORD indicates the upper end of the reordering window. The normative definition of these PDCP state variables are provided in more detail in TS 38.323, clause 7.1.

In the present disclosure, a new PDCP state variable is also proposed for use in some implementations. This new PDCP state variable can be referred to herein as RX_DISCARD. RX_DISCARD can indicate a number of consecutively discarded PDCP PDUs. This RX_DISCARD PDCP state variable can get updated from a discard indication received by a PDCP transmitter and be reset to 0 after a reordering operation (with respect to the discard) is completed.

### Updating of PDCP Variables Regardless of Whether Reordering Timer is Running

FIG. 2 is a flowchart of a process 200 for updating PDCP state variables by a PDCP receiver based on a received discard indication. The process 200 will be described herein as being performed by a PDCP receiver that receives a PDCP discard indication from a PDCP transmitter. For purposes of the present disclosure, a PDCP receiver can be a UE or base station that receives PDCP discard indication from a PDCP transmitter. Likewise, a PDCP transmitter can be a UE or base station that transmits a PDCP discard indication and one or more discarded PDCP PDUs to PDCP receiver, which can be either a UE or base station. Thus, communication between a PDCP transmitter and a PDCP receiver can be between a UE to base station communication, base station to UE communication, or UE to UE communication. In some cases, the PDCP receiver may be able to infer the number of discarded packets by observing the regular packet header of a PDU Set, which may contain an end-of-PDU Set indication for one PDU Set and a start-of-PDU Set indication for the next PDU Set wherein both PDU Sets are in sequence but the PDCP sequence number associated with the last PDU Set header of PDU Set 1 and the first PDU Set header of PDU Set 2 is not in-sequence. From a receiver point of view, this can provide information similar to a discard indication.

A PDCP receiver can begin execution of the process 200 by receiving a discard indication indicating one or more PDCP PDUs as discarded PDUs (210).

Then, based on receipt of the discard indication, the PDCP receiver can continue execution of the process 200 by updating the values of one or more PDCP state variables based on the received discard indication (220).

In some implementations, the one or more PDCP state variables can include a first state variable corresponding to a sequence count value following a sequence count value associated with a PDCP Data PDU that triggered the reordering timer. This first state variable can correspond to the RX_REORD PDCP state variable. In such implementations, updating the first state variable can include the PDCP receiver adjusting a value of the first state variable based on a number of subsequently discarded PDUs.

In some implementations, the one or more PDCP state variables can include a second state variable corresponding to a sequence count value of a first PDCP SDU that is (i) not delivered to an upper layer and (ii) still waited for by a receiving device. The second state variable can correspond to the RX_DELIV PDCP state variable. In such implementations, updating the second state variable can include the PDCP receiver adjusting a value of the second state variable based on a number of subsequently discarded PDUs.

### Updating a Boundary of a PDCP Reordering Window

In some implementations, the PDCP receiver is made aware of the range of received PDCP PDU sequence numbers (SNs) or COUNTs that have been discarded at the transmitter, the receiver can utilize this information to minimize the reordering delay.

The COUNT value is a 32 bit value that is incremented in a round robin fashion whereas the value range of the PDCP sequence number (SN) depends on network configuration. The PDCP sequence number (SN) can be 12 or 18 bits, as defined in TS 38.323 clause 6.3.

The COUNT value is composed of a HFN and the PDCP SN. The size of the HFN part in bits is equal to 32 minus the length of the PDCP SN.

In some implementations, for example, upon reception of a discard indication from the transmitter, the PDCP receiver can treat the last PDU (or packet) before and the first PDU (or packet) after the range of discarded SNs as in-sequence. Then, the PDCP receiver can update the PDCP reordering window. In some implementations, the PDCP receiver can determine whether to update an upper bound of the PDCP reordering window or a lower bound of a PDCP reordering window based on whether a reordering timer such as t-Reordering is running.

If a reordering timer such as t-Reordering is not running, then the PDCP receiver can update the lower end of the reordering window RX_DELIV to: RX_DELIV=RX_DELIV+x, where x is the number of subsequently discarded PDUs (or packets) in one or multiple PDU Sets, considering modulo operation. Here, subsequently discarded means subsequent to the last packet before the SN gap. In some implementations, the PDCP receiver can perform this update of the lower end of the reordering window during any part of PDCP operation. In other implementations, the PDCP receiver can perform this update of the lower end of the reordering window during 38.323, clause 5.2.2, which defines a PDCP receive operation.

Alternatively, if a reordering timer such as t-Reordering is running, then the PDCP receiver can update the upper end of the reordering window RX_REORD to: RX_REORD=RX_REORD+x, where x is the number of subsequently discarded PDUs (or packets) in one or multiple PDU Set, considering modulo operation. In some implementations, the PDCP receiver can perform this update of the upper end of the reordering window during any part of PDCP operation. In other implementations, the PDCP receiver can perform this update of the lower end of the reordering window during 38.323, clause 5.2.2, which defines a PDCP receive operation.

In some implementations, the PDCP receiver may have to adjust a portion of a PDCP receive operation such as the PDCP receive operation described by 38.323, clause 5.2.2. For example, when T-Reordering is running, skipped SNs refer to discarded PDCP PDUs/COUNT values pointed to by the discard indication (Discard Marker) from the transmitter. In some implementations, the number of consecutively discarded PDUs may also be stored in a new PDCP state variable, which gets updated from the discard indication and is reset to 0 after reordering operation (with respect to the discard) got completed.

In some implementations, the number of consecutively discarded PDUs may be stored using a new PDCP state variable RX_DISCARD.

In some implementations, If RCVD_COUNT=RX_DELIV, then the PDCP receiver can deliver to upper layers in ascending order of the associated sequence number or COUNT value after performing header decompression, if not decompressed before, all stored PDCP SDU(s) with consecutively associated COUNT value(s) from COUNT=RX_DELIV (by skipping SNs indicated as discarded). Then, the PDCP receiver can update RX_DELIV to the COUNT value of the first PDCP SDU which has not been delivered to upper layers, with COUNT value>RX_DELIV.

In such implementations, a discard indication from the transmitter can be received while the reordering processing is already ongoing. For the case when a discard indication is available already before reception of the first packet (e.g. when the reception buffer is empty and all packets are already delivered to upper layers) the receiver may directly update the SN position based on the received discard status, for example, by updating RX_DELIV (as for the case when t_Reordering is not running).

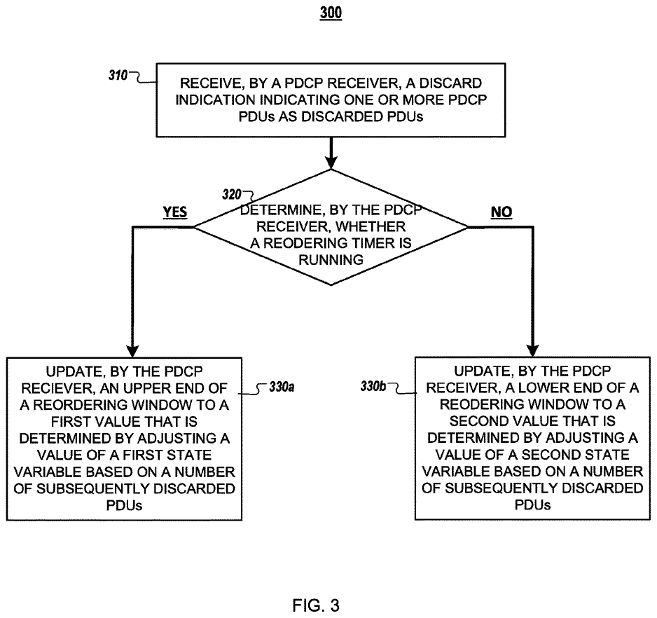

FIG. 3 is a flowchart of a process 300 for using updated PDCP state variables by a PDCP receiver to set a boundary of a PDCP reordering window. The process 300 will be described herein as being performed by a PDCP receiver that receives a PDCP discard indication from a PDCP transmitter. For purposes of the present disclosure, a PDCP receiver can be a UE or base station that receives PDCP discard indication from a PDCP transmitter. Likewise, a PDCP transmitter can be a UE or base station that transmits a PDCP discard indication and one or more discarded PDCP PDUs to PDCP receiver, which can be either a UE or base station. Thus, communication between a PDCP transmitter and a PDCP receiver can be between a UE to base station communication, base station to UE communication, or UE to UE communication.

A PDCP receiver can begin execution of the process 300 by receiving a discard indication indicating one or more PDCP PDUs as discarded PDUs (310).

The PDCP receiver can continue execution of the process 300 by determining, by the PDCP receiver, whether a reordering timer is running (320).

Then, based on a determination by the PDCP receiver at stage 320 that the reordering timer is running, the PDPC receiver can continue execution of the process 300 at stage 330a by updating an upper end of the reordering window to a first value that is determined by adjusting a value of a first state variable based on a number of subsequently discarded PDUs. In such implementations, the value of the first state variable corresponds to a sequence count value following a sequence count value associated with a PDCP Data PDU that triggered the reordering timer. This first state variable can be the RX_REORD PDCP state variable. In some implementations, adjusting the value of the first state variable such as RX_REORD based on a number of subsequently discarded PDUs can include adding the number of subsequently discarded PDUs to the value of RX_REORD.

Alternatively, based on a determination by the PDCP receiver at stage 320 that the reordering timer is not running, the PDCP receiver can continue execution of the process 300 at stage 330b by updating a lower end of the reordering window to a second value that is determined by adjusting a value of a second state variable based on the number of subsequently discarded PDUs. In such implementations, value of the second state variable corresponds to a sequence count value of a first PDCP SDU that is (i) not delivered to an upper layer and (ii) still waited for by a receiving device. This second state variable can be the RX_DELIV PDCP state variable. In some implementations, adjusting the value of the second state variable such as RX_DELIV based on a number of subsequently discarded PDUs can include adding the number of subsequently discarded PDUS to the value of RX_DELIV.

In some implementations, the PDCP receiver can continue execution of the process 300 by updating a value of a third state variable based on a number of consecutively discarded PDUs. This third state variable can include the new PDCP state variable RX_DISCARD, proposed by the present disclosure.

In some implementations, the PDCP receiver can continue execution of the process 300 by determining that (i) a value of the second state variable corresponds to a sequence count value of a first PDCP SDU that is (a) not delivered to an upper layer and (b) still waited for by a receiving device and (ii) a value of the third state variable based on a number of consecutively discarded PDUs in a PDU Set. Then, based on a determination by the PDCP receiver that the value of the second state variable is equal to the value of the third state variable, the PDCP receiver can continue execution of the process 300 by delivering to an upper layer protocol all stored PDCP SDUs with consecutively associated values starting from sequence number equal to a value of the second state variable, and updating, by the PDCP receiver, the value of the second state variable to a sequence number of a first PDCP SDU that has not been delivered to upper layers. In some implementations, the updated value of the second state variable is a sequence number greater than the value of the second state variable before updating.

In some implementations, the stored PDCP SDUs with consecutively associated values are delivered after header decompression.

### Processing of Discarded PDCP PDUs by a PDCP Receiver

In implementations, a transmitter may still deliver some or all of the discarded PDUs even though they are signaled or declared as discarded. For example, when packet discarding happens after a PDU has been enciphered or when to be discarded PDUs are already submitted to lower layers and the PDUs are already part of a time-critical operation in RLC (with state variables assigned) or MAC (LCP is running, ongoing generation of a MAC PDU, etc.), discarding may be more complicated (involves concurrency, causing high CPU load), so the transmitter may still send those PDUs. Thus, in general, the more to be discarded PDUs that are transmitted to the PDCP receiver for processing (and thus not discarded by the PDCP transmitter), the greater the reduction in overhead processing by the PDCP transmitter.

When receiving a PDU that has been indicated or declared (e.g., by the transmitter) as discarded, the receiver may either discard the PDU or deliver it to upper layers. A discard of such PDUs may already happen at MAC (to prevent subsequent processing in upper layers), but could be done in RLC or PDCP as well. The main assumption (applicable to this disclosure) is that the discarding happens in the PDCP receiver.

Accordingly, in some implementations, the PDCP receiver can discard the PDCP PDUs indicated for discarding by a discard indicator. This option helps save resources on the next hops and is preferred. Alternatively, in some implementations, the receiver can nevertheless deliver the PDCP PDUs indicated by a discard indicator for discarding to upper layers. This alternative option minimizes the impact to existing specifications and still provides some redundancy. Either of these alternatives can be enabled by explicit network configuration or defined in the specification

In yet another alternative, the PDCP transmitter may inform the PDCP receiver of PDCP packets that are expired but which it will continue to transmit, e.g., due to the constrains above. In such cases the PDCP receiver can decide how to treat those packets. For example, it may wait a predetermined amount of time to discard the PDCP packets indicated as discarded or expired or discard the PDCP packets indicated as discarded or expired directly (e.g., immediately without waiting the predetermined amount of time).

In conventional systems, for AM DRBs, when upper layers request a PDCP data recovery for a radio bearer, the transmitting PDCP entity shall perform retransmission of all the PDCP Data PDUs previously submitted to re-established or released AM RLC entities in ascending order of the associated COUNT values for which the successful delivery has not been confirmed by lower layers, following the data submission procedure in clause 5.2.1.

However, when upper layers request a PDCP data recovery for a radio bearer after packet discarding and assuming that the RLC/MAC layers did transmit some of the discarded PDUs regardless (e.g., to minimize SN gaps in RLC or to minimize complexity) earlier, a retransmission of those discarded PDUs is a waste and can be avoided. Thus, the specifications can be extended to avoid this case with respect to discarded PDUs stored at lower layers, as discarding is expected to happen on a more regular basis than in earlier releases.

Moreover, from an upper layer perspective obviously the data recovery procedure should not request to recover discarded packets in the first place. But there may still be packets stored at lower layers.

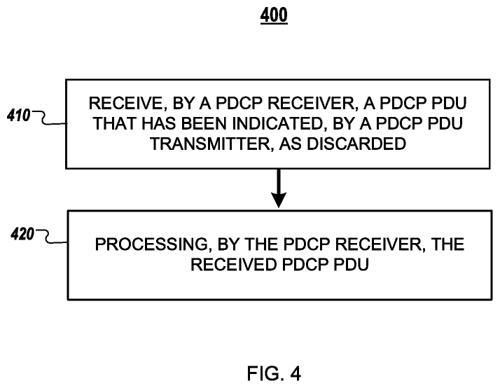

FIG. 4 is a flowchart of a process 400 for processing a discarded PDCP PDU by a PDCP receiver. The process 400 will be described herein as being performed by a PDCP receiver that receives a PDCP discard indication from a PDCP transmitter. For purposes of the present disclosure, a PDCP receiver can be a UE or base station that receives PDCP discard indication from a PDCP transmitter. Likewise, a PDCP transmitter can be a UE or base station that transmits a PDCP discard indication and one or more discarded PDCP PDUs to PDCP receiver, which can be either a UE or base station. Thus, communication between a PDCP transmitter and a PDCP receiver can be between a UE to base station communication, base station to UE communication, or UE to UE communication.

A PDCP receiver can begin execution of the process 400 by receiving a PDCP PDU that has been indicated, by a PDCP PDU transmitter, as discarded (410).

The PDCP receiver can continue execution of the process 400 by processing the received PDCP PDU. In some implementations, processing the received PDCP PDU by the PDCP receiver can include the PDCP receiver discarding the received PDCP PDU. In some implementations, discarding the received PDCP PDU can include the PDCP receiver discarding the received PDCP PDU only after a predetermined period of time has expired after receipt of the PDCP PDU. Alternatively, in other implementations, discarding the received PDCP PDU by the PDCP receiver can include the PDCP receiver discarding the received PDCP PDU immediately upon receipt.

Alternatively, in other implementations, processing the received PDCP PDU by the PDCP receiver can include the PDCP receiver delivering the received PDCP PDU to one or more upper layer protocols.

In some implementations, execution of the process 400 can include the PDCP receiver receiving a request for retransmission of one or more PDCP PDUs that include the received PDCP PDU that was indicated as discarded, and prohibiting, by the PDCP receiver, a request for retransmission of the received PDCP PDU that was indicated as discarded from being transmitted to the PDCP transmitter.

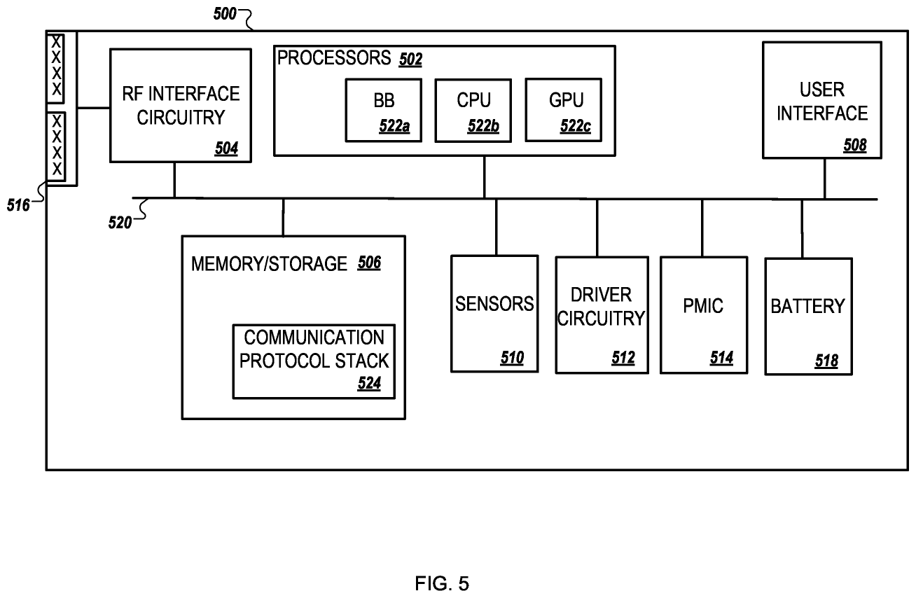

FIG. 5 illustrates a UE 500, according to some implementations. The UE 500 may be similar to and substantially interchangeable with UE 102 of FIG. 1.

The UE 500 may be any mobile or non-mobile computing device, such as, for example, mobile phones, computers, tablets, industrial wireless sensors (for example, microphones, pressure sensors, thermometers, motion sensors, accelerometers, inventory sensors, electric voltage/current meters, etc.), video devices (for example, cameras, video cameras, etc.), wearable devices (for example, a smart watch), relaxed-IoT devices.

The UE 500 may include processors 502, RF interface circuitry 504, memory/storage 506, user interface 508, sensors 510, driver circuitry 512, power management integrated circuit (PMIC) 514, antenna structure 516, and battery 518. The components of the UE 500 may be implemented as integrated circuits (ICs), portions thereof, discrete electronic devices, or other modules, logic, hardware, software, firmware, or a combination thereof. The block diagram of FIG. 5 is intended to show a high-level view of some of the components of the UE 500. However, some of the components shown may be omitted, additional components may be present, and different arrangement of the components shown may occur in other implementations.

The components of the UE 500 may be coupled with various other components over one or more interconnects 520, which may represent any type of interface, input/output, bus (local, system, or expansion), transmission line, trace, optical connection, etc. that allows various circuit components (on common or different chips or chipsets) to interact with one another.

The processors 502 may include processor circuitry such as, for example, baseband processor circuitry (BB) 522A, central processor unit circuitry (CPU) 522B, and graphics processor unit circuitry (GPU) 522C. The processors 502 may include any type of circuitry or processor circuitry that executes or otherwise operates computer-executable instructions, such as program code, software modules, or functional processes from memory/storage 506 to cause the UE 500 to perform operations as described herein.

In some implementations, the baseband processor circuitry 522A may access a communication protocol stack 524 in the memory/storage 506 to communicate over a 3GPP compatible network. In general, the baseband processor circuitry 522A may access the communication protocol stack to: perform user plane functions at a physical (PHY) layer, medium access control (MAC) layer, radio link control (RLC) layer, packet data convergence protocol (PDCP) layer, service data adaptation protocol (SDAP) layer, and PDU layer; and perform control plane functions at a PHY layer, MAC layer, RLC layer, PDCP layer, RRC layer, and a non-access stratum layer. In some implementations, the PHY layer operations may additionally/alternatively be performed by the components of the RF interface circuitry 504. The baseband processor circuitry 522A may generate or process baseband signals or waveforms that carry information in 3GPP-compatible networks. In some implementations, the waveforms for NR may be based cyclic prefix orthogonal frequency division multiplexing (OFDM) “CP-OFDM” in the uplink or downlink, and discrete Fourier transform spread OFDM “DFT-S-OFDM” in the uplink.

The memory/storage 506 may include one or more non-transitory, computer-readable media that includes instructions (for example, communication protocol stack 524) that may be executed by one or more of the processors 502 to cause the UE 500 to perform various operations described herein. The memory/storage 506 include any type of volatile or non-volatile memory that may be distributed throughout the UE 500. In some implementations, some of the memory/storage 506 may be located on the processors 502 themselves (for example, L1 and L2 cache), while other memory/storage 506 is external to the processors 502 but accessible thereto via a memory interface. The memory/storage 506 may include any suitable volatile or non-volatile memory such as, but not limited to, dynamic random access memory (DRAM), static random access memory (SRAM), erasable programmable read only memory (EPROM), electrically erasable programmable read only memory (EEPROM), Flash memory, solid-state memory, or any other type of memory device technology.

The RF interface circuitry 504 may include transceiver circuitry and radio frequency front module (RFEM) that allows the UE 500 to communicate with other devices over a radio access network. The RF interface circuitry 504 may include various elements arranged in transmit or receive paths. These elements may include, for example, switches, mixers, amplifiers, filters, synthesizer circuitry, control circuitry, etc.

In the receive path, the RFEM may receive a radiated signal from an air interface via antenna structure 516 and proceed to filter and amplify (with a low-noise amplifier) the signal. The signal may be provided to a receiver of the transceiver that downconverts the RF signal into a baseband signal that is provided to the baseband processor of the processors 502.

In the transmit path, the transmitter of the transceiver up-converts the baseband signal received from the baseband processor and provides the RF signal to the RFEM. The RFEM may amplify the RF signal through a power amplifier prior to the signal being radiated across the air interface via the antenna 516. In various implementations, the RF interface circuitry 504 may be configured to transmit/receive signals in a manner compatible with NR access technologies.

The antenna 516 may include antenna elements to convert electrical signals into radio waves to travel through the air and to convert received radio waves into electrical signals. The antenna elements may be arranged into one or more antenna panels. The antenna 516 may have antenna panels that are omnidirectional, directional, or a combination thereof to enable beamforming and multiple input, multiple output communications. The antenna 516 may include microstrip antennas, printed antennas fabricated on the surface of one or more printed circuit boards, patch antennas, phased array antennas, etc. The antenna 516 may have one or more panels designed for specific frequency bands including bands in FR1 or FR2.

The user interface 508 includes various input/output (I/O) devices designed to enable user interaction with the UE 500. The user interface 508 includes input device circuitry and output device circuitry. Input device circuitry includes any physical or virtual means for accepting an input including, inter alia, one or more physical or virtual buttons (for example, a reset button), a physical keyboard, keypad, mouse, touchpad, touchscreen, microphones, scanner, headset, or the like. The output device circuitry includes any physical or virtual means for showing information or otherwise conveying information, such as sensor readings, actuator position(s), or other like information. Output device circuitry may include any number or combinations of audio or visual display, including, inter alia, one or more simple visual outputs/indicators (for example, binary status indicators such as light emitting diodes “LEDs” and multi-character visual outputs), or more complex outputs such as display devices or touchscreens (for example, liquid crystal displays “LCDs,” LED displays, quantum dot displays, projectors, etc.), with the output of characters, graphics, multimedia objects, and the like being generated or produced from the operation of the UE 500.

The sensors 510 may include devices, modules, or subsystems whose purpose is to detect events or changes in its environment and send the information (sensor data) about the detected events to some other device, module, subsystem, etc. Examples of such sensors include, inter alia, inertia measurement units including accelerometers, gyroscopes, or magnetometers; microelectromechanical systems or nanoelectromechanical systems including 3-axis accelerometers, 3-axis gyroscopes, or magnetometers; level sensors; temperature sensors (for example, thermistors); pressure sensors; image capture devices (for example, cameras or lensless apertures); light detection and ranging sensors; proximity sensors (for example, infrared radiation detector and the like); depth sensors; ambient light sensors; ultrasonic transceivers; microphones or other like audio capture devices; etc.

The driver circuitry 512 may include software and hardware elements that operate to control particular devices that are embedded in the UE 500, attached to the UE 500, or otherwise communicatively coupled with the UE 500. The driver circuitry 512 may include individual drivers allowing other components to interact with or control various input/output (I/O) devices that may be present within, or connected to, the UE 500. For example, driver circuitry 512 may include a display driver to control and allow access to a display device, a touchscreen driver to control and allow access to a touchscreen interface, sensor drivers to obtain sensor readings of sensor circuitry 510 and control and allow access to sensor circuitry 510, drivers to obtain actuator positions of electro-mechanic components or control and allow access to the electro-mechanic components, a camera driver to control and allow access to an embedded image capture device, audio drivers to control and allow access to one or more audio devices.

The PMIC 514 may manage power provided to various components of the UE 500. In particular, with respect to the processors 502, the PMIC 514 may control power-source selection, voltage scaling, battery charging, or DC-to-DC conversion.

In some implementations, the PMIC 514 may control, or otherwise be part of, various power saving mechanisms of the UE 500. A battery 518 may power the UE 500, although in some examples the UE 500 may be mounted deployed in a fixed location, and may have a power supply coupled to an electrical grid. The battery 518 may be a lithium ion battery, a metal-air battery, such as a zinc-air battery, an aluminum-air battery, a lithium-air battery, and the like. In some implementations, such as in vehicle-based applications, the battery 518 may be a typical lead-acid automotive battery.

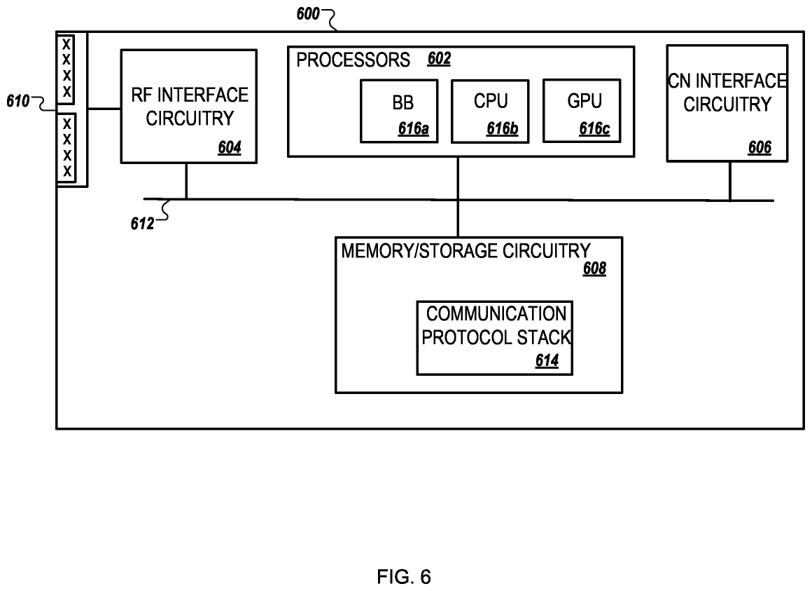

FIG. 6 illustrates an access node 600 (e.g., a base station or gNB), according to some implementations. The access node 600 may be similar to and substantially interchangeable with base station 104. The access node 600 may include processors 602, RF interface circuitry 604, core network (CN) interface circuitry 606, memory/storage circuitry 608, and antenna structure 610.

The components of the access node 600 may be coupled with various other components over one or more interconnects 612. The processors 602, RF interface circuitry 604, memory/storage circuitry 608 (including communication protocol stack 614), antenna structure 610, and interconnects 612 may be similar to like-named elements shown and described with respect to FIG. 5. For example, the processors 602 may include processor circuitry such as, for example, baseband processor circuitry (BB) 616A, central processor unit circuitry (CPU) 616B, and graphics processor unit circuitry (GPU) 616C.

The CN interface circuitry 606 may provide connectivity to a core network, for example, a 5th Generation Core network (5GC) using a 5GC-compatible network interface protocol such as carrier Ethernet protocols, or some other suitable protocol. Network connectivity may be provided to/from the access node 600 via a fiber optic or wireless backhaul. The CN interface circuitry 606 may include one or more dedicated processors or FPGAs to communicate using one or more of the aforementioned protocols. In some implementations, the CN interface circuitry 606 may include multiple controllers to provide connectivity to other networks using the same or different protocols.

As used herein, the terms “access node,” “access point,” or the like may describe equipment that provides the radio baseband functions for data and/or voice connectivity between a network and one or more users. These access nodes can be referred to as BS, gNBs, RAN nodes, eNBs, NodeBs, RSUs, TRxPs or TRPs, and so forth, and can include ground stations (e.g., terrestrial access points) or satellite stations providing coverage within a geographic area (e.g., a cell). As used herein, the term “NG RAN node” or the like may refer to an access node 600 that operates in an NR or 5G system (for example, a gNB), and the term “E-UTRAN node” or the like may refer to an access node 600 that operates in an LTE or 4G system (e.g., an eNB). According to various implementations, the access node 600 may be implemented as one or more of a dedicated physical device such as a macrocell base station, and/or a low power (LP) base station for providing femtocells, picocells or other like cells having smaller coverage areas, smaller user capacity, or higher bandwidth compared to macrocells.

In some implementations, all or parts of the access node 600 may be implemented as one or more software entities running on server computers as part of a virtual network, which may be referred to as a CRAN and/or a virtual baseband unit pool (vBBUP). In V2X scenarios, the access node 600 may be or act as a “Road Side Unit.” The term “Road Side Unit” or “RSU” may refer to any transportation infrastructure entity used for V2X communications. An RSU may be implemented in or by a suitable RAN node or a stationary (or relatively stationary) UE, where an RSU implemented in or by a UE may be referred to as a “UE-type RSU,” an RSU implemented in or by an eNB may be referred to as an “eNB-type RSU,” an RSU implemented in or by a gNB may be referred to as a “gNB-type RSU,” and the like.

Various components may be described as performing a task or tasks, for convenience in the description. Such descriptions should be interpreted as including the phrase “configured to.” Reciting a component that is configured to perform one or more tasks is expressly intended not to invoke 35 U.S.C. § 112(f) interpretation for that component.

### Other Embodiments

Particular embodiments of the present disclosure have been described. Other embodiments are within the scope of the following claims. For example, the steps recited in the claims or any processes described herein combined, performed in a different order, or both, and still achieve desirable results.

1-11. (canceled)

12. One or more processors configured to, when executing instructions stored in a memory, perform operations comprising:
receiving one or more packet data convergence protocol (PDCP) data units comprising respective discard indications;
determining respective values of one or more state variables associated with a receiving PDCP entity;
determining a status of a PDCP reordering timer; and
updating a value of a first state variable based at least on (i) the status of the PDCP reordering timer, (ii) respective count values of the one or more PDCP data units with respective discard indications, and (ii) the respective values of the one or more state variables associated with the receiving PDCP entity.

13. The one or more processors of claim 12, wherein the one or more state variables comprise an RX_NEXT state variable that indicates a count value of a next PDCP data unit expected to be received.

14. The one or more processors of claim 12, wherein the one or more state variables comprise an RX_DELIV state variable that indicates a count value of a first PDCP data unit not delivered to upper layers.

15. The one or more processors of claim 12, wherein the one or more state variables comprise an RX_REORD state variable that indicates a first count value following a second count value associated with a PDCP data unit that triggered the PDCP reordering timer.

16. The one or more processors of claim 12, the operations further comprising identifying a set of discarded PDCP data units based at least on the respective discard indications.

17. The one or more processors of claim 16, the operations further comprising incrementing a count value associated with one of the discarded PDCP data units.

18. The one or more processors of claim 17, wherein updating the value of the first state variable comprises setting the value of the first state variable to the incremented count value of the discarded PDCP data unit.

19. The one or more processors of claim 16, the operations further comprising determining whether the value of the first state variable is equal to a count value associated with any of the discarded PDCP data units.

20. The one or more processors of claim 16, the operations further comprising determining whether the value of the first state variable is less than or equal to a count value of a last discarded PDCP data unit in the set of discarded PDCP data units.

21. The one or more processors of claim 12, the operations further comprising delivering, to upper layers, all stored PDCP data units with consecutively associated count values starting from a specified value, wherein consecutively associated count values include count values of stored PDCP data units and discarded PDCP data units.

22. The one or more processors of claim 12, wherein updating the value of the first state variable comprises updating the value of the first state variable to a count value of a first PDCP data unit that has not been delivered to upper layers and is not considered discarded, wherein the count value of the first PDCP data unit is greater than a previous value of the first state variable.

23. The one or more processors of claim 12, wherein determining the status of the PDCP reordering timer comprises determining whether the PDCP reordering timer is running.

24. The one or more processors of claim 12, the operations further comprising determining a PDCP reordering window based at least on the one or more state variables associated with the receiving PDCP entity.

25. The one or more processors of claim 12, wherein updating the value of the first state variable comprises adjusting the value of the first state variable based at least on a number of subsequently discarded PDCP data units.

26. A method comprising:
receiving one or more PDCP data units comprising respective discard indications;
determining respective values of one or more state variables associated with a receiving PDCP entity;
determining a status of a PDCP reordering timer; and
updating a value of a first state variable based at least on (i) the status of the PDCP reordering timer, (ii) respective count values of the one or more PDCP data units with respective discard indications, and (ii) the respective values of the one or more state variables associated with the receiving PDCP entity.

27. The method of claim 26, wherein the one or more state variables comprise an RX_NEXT state variable that indicates a count value of a next PDCP data unit expected to be received.

28. The method of claim 26, wherein the one or more state variables comprise an RX_DELIV state variable that indicates a count value of a first PDCP data unit not delivered to upper layers.

29. The method of claim 26, wherein the one or more state variables comprise an RX_REORD state variable that indicates a first count value following a second count value associated with a PDCP data unit that triggered the PDCP reordering timer.

30. The method of claim 26, further comprising identifying a set of discarded PDCP data units based at least on the respective discard indications.

31. An apparatus comprising one or more processors configured to perform operations comprising:
receiving one or more PDCP data units comprising respective discard indications;
determining respective values of one or more state variables associated with a receiving PDCP entity;
determining a status of a PDCP reordering timer; and
updating a value of a first state variable based at least on (i) the status of the PDCP reordering timer, (ii) respective count values of the one or more PDCP data units with respective discard indications, and (ii) the respective values of the one or more state variables associated with the receiving PDCP entity.
